(19) United States
(12) Patent Application Publication
(10) Pub. No.: US 2006/0009563 A1
(43) Pub. Date: Jan. 12, 2006

(54) Aqueous metal oxide composition and method for dip coating and electrophotographic applications, and electrophotographic equipment members, particularly electrophotographic drum

(75) Inventor: Michel F. Molaire, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/887,968

(22) Filed: Jul. 9, 2004

(51) Int. Cl. B05D 1/18; C08K 3/18

(52) U.S. Cl. 524/430; 427/430.1

(57) ABSTRACT

This invention relates to an aqueous composition for dip coating electrophotographic process equipment members and to a method for coating such electrophotographic members and to a coating produced on such electrophotographic process members by the use of the present composition and method. The composition includes a dispersion of a finely divided metal oxide in water or alcohol, a latex polymer composition, a water-soluble viscosity enhancer and a water miscible volatile solvent.

### FIELD OF THE INVENTION

This invention relates to an aqueous composition for dip coatings and photoconductor films are effectively coated by the use of the composition by dip coating and the like. The invention further relates to a method for coating such electrophotographic members and to a coating produced on such electrophotographic members by the use of the present composition and method.

### BACKGROUND OF THE INVENTION

Dip coating, hopper coating, spray coating, knife coating and other processes are used to coat open ended cylindrical drums, photoconductor films and the like for electrophotographic applications, as well known to those skilled in the art. These coating techniques are used to produce uniform thin films that are desirably obtained by proper control of the coating materials and solutions. An important material property is the volatility of the coating solvent. It is also essential that the coated liquid dry as fast as possible on the coated element to prevent run-back, sagging and the like that may cause axial thickness non-uniformity.

Previously, such coating processes have used compositions that included solvents, such as halogenated solvents, which are undesirable from an environmental point of view. Environmental concern is directing the coating industry to consider abandoning certain solvents such as these halogenated solvents. One of the preferable solvents is water but unfortunately water has a relatively low viscosity and compositions based upon water have been prone to produce non-uniform and very thin coatings by existing coating techniques.

Water is a desirable solvent because many electrophotographic applications use pigment dispersions, such as nanoparticle size metal oxide dispersions, that perform better with smaller particle size distribution. In aqueous medium, it is easier to stabilize such small particles electrostatically. Usually steric stabilization is required with organic media. One of the consequences of the use of organic media is that the small particle size pigment particles tend to agglomerate.

One such application is the use of metal oxide, doped coatings as smoothing layers for dual and single layer photoconductors. It would be advantageous to coat such layers from aqueous, nanoparticle size dispersions of metal oxides that can provide relatively transparent and uniform smoothing layers.

Accordingly, considerable effort has been directed to the development of aqueous solutions that can achieve these objectives without the use of the undesirable halogenated organic solvents.

### SUMMARY OF THE INVENTION

According to the present invention, these objectives are achieved by a composition for dip coating an article comprising at least one finely-divided metal oxide, the composition further comprising: a dispersion of at least one finely-divided particulate metal oxide in water or alcohol, the dispersion containing at least about 15 weight percent (wt. %) metal oxide and being present in the composition in an amount sufficient to produce a metal oxide content in the coating from about 30 to about 80 wt. %; a latex polymer composition in an amount to produce a latex polymer content from about 15 to about 59.5 wt. % in the coating; a water soluble viscosity enhancer in an amount less than about 10 wt. % of the coating; and a water miscible, volatile solvent in an amount equal to from about 35 to about 60 wt. % of the water in the composition.

The present invention further comprises a method for coating an outside surface of an electrophotographic member, the method comprising preparing a coating composition comprising; a dispersion of at least one finely-divided particulate metal oxide in water or alcohol, the dispersion containing at least about 15 wt. % metal oxide and being present in an amount sufficient to produce a metal oxide content in the coating from about 40 to about 80 wt. %; a latex polymer composition in an amount to produce a latex polymer content from about 15 to about 59.5 wt. % in the coating; a water soluble viscosity enhancer in an amount less than about 10 wt. % of the coating; and a water miscible, volatile solvent in an amount equal to from about 35 to about 60 wt. % of the water in the composition.

The present invention also comprises a coating composition for an electrophotographic member comprising: from about 40 to about 80 wt. % of at least one finely-divided metal oxide; from about 15 to about 59.5 wt. % of a latex polymer; and, from about 0.5 to about 5 wt. % of an aqueous soluble viscosity enhancer.

### BRIEF DESCRIPTION OF THE DRAWINGS

FIG. 1 is a graphic display of data from test Examples 5-10; and,

FIG. 2 is a graphic representation of data from Examples 5-10.

### DESCRIPTION OF PREFERRED EMBODIMENTS

According to the present invention, a composition for dip coating an article, with a coating comprising at least one finely-divided metal oxide is provided, the composition comprising: a dispersion of at least one finely-divided particulate metal oxide in water or alcohol, the dispersion containing at least about 15 wt. % metal oxide and being present in an amount sufficient to produce a metal oxide content in the coating from about 40 to about 80 wt. %; a latex polymer composition in an amount to produce a latex polymer content from about 15 to about 59.5 wt. % in the coating; an aqueous soluble viscosity enhancer in an amount less than about 10 wt. % of the coating; and a water miscible, volatile solvent in an amount equal to from about 35 to about 60 wt. % of the water in the composition is provided for coating electrophotographic process elements such as drums and the like used for the generation of electrostatic images and the like. Such drums are used for a variety of applications and in all the applications it is desirable that the coatings applied to the drums be smooth and uniform and of a substantial thickness.

With the use of water, two problems are immediately encountered. First the water has a relatively low evaporation rate. Secondly the water tends to be very fluid which results in the production of thinner coatings. These difficulties are overcome by the use of the composition described above. By the proper combination of these four components in the proper ratio, axially uniform and transparent, relatively thick metal oxide coatings can be achieved by the dip coating process and other coating processes. However, dip coating is a preferred process.

By the use of this composition in the method described herein, it is possible to formulate metal oxide compositions of the various metal oxides that will coat in near identical coating conditions. This is accomplished by keeping all the components the same and in the same optimum composition and simply substituting different nanoparticle size aqueous metal oxides for each other. The viscosity enhancer controls the rheological properties of the coating composition containing these various metal oxides.

The metal oxides are provided as an aqueous or alcohol dispersion of the finely divided particulate metal oxides. The metal oxides are desirably stably dispersed in an aqueous solution of water or alcohol. Desirably the metal oxide concentration in the dispersion is from about to 15 to about 60, preferably from about 20 to about 30 wt. % and is adjusted to provide a metal oxide content in the resulting coating from about 40 to about 80, preferably from about 50 to about 75 wt. % the higher the metal oxide in the dispersion, the easier it is to formulate the coating dispersion.

Alcohols used in the dispersion are desirably selected from the group consisting of methanol, ethanol, and propanol. Methanol is the preferred alcohol.

This dispersion is typically added to the composition in an amount equal to about 15 to about 90 wt. % of the composition. This wt. % can vary substantially depending upon the concentration of the metal oxides in the aqueous or alcoholic dispersion. Desirably, the amount of dispersion added and the concentration of metal oxide if adjusted to provide a desired metal oxide concentration in the resulting coating produced upon drying the coated electrophotographic element.

Suitable metal oxides are selected from the group consisting of oxides of titanium, zirconium, induim, antimony, tin, aluminum and mixtures thereof.

Preferred metal oxides are tin oxide, titanium dioxide and antimony dioxide. Of course, mixtures of metal oxides may be used if desired. Desirably, the resulting coating is a smooth, uniformly thick, transparent and uniform layer. This layer has the effect of smoothing the surface of the electrophotographic process element and providing a conductive layer on the coated surface electrophotographic process element.

The latex polymer composition comprises a latex polymer composition or a polymer soluble in water, alcohol/water mixtures or alcohol. The alcohols are desirably selected from the group consisting of methanol, ethanol, and propanol. Methanol is the preferred alcohol.

Desirably, the latex polymer is selected from the group consisting of polyurethane dispersion, polyvinyl polyol, or polyester polyol aqueous dispersions. The latex polymer should be compatible with the metal oxide dispersion, and not destabilize the dispersion causing pigment agglomeration. Ionic dispersions are preferably anionic. In particular ammonium carboxylate dispersing groups are preferred. Easily volatized amines such as tri-ethyl amine and ammonia are preferred as dispersing groups that can be eliminated during thermal curing to render the polymer more insulating.

Latex polymers are preferred over water-soluble polymers. Water-soluble polymers tend to absorb water under certain humidity conditions. They can impart environmental instability to the electrophotographic elements.

Cross-linking agents can be added to the polyols to induce cross-linking. In one stable system, water dispersible blocked isocyanates are used for cross-linking at high temperature and storage stability at usage temperature.

A water-soluble viscosity enhancer polymeric or monomeric material, which is effective at a relatively low concentration is included at concentrations preferably below 10 wt. % and preferably below about 5 wt. % in the resulting solid coating. The viscosity enhancer increases the viscosity of the aqueous solution and desirably becomes exponentially more effective as the water and other solid concentrations are reduced.

Viscosity enhancers are broadly classified as non-associative and associative. The non-associative viscosity enhancers impart their effect by the hydrodynamic, volume exclusion (HDV) mechanism. A substance in solution occupies some volume with the solution, thereby excluding the possibility of any other substances occupying that same volume. As more solute is added, less volume is available within the solution, with the observable effect noted as an increase in solution viscosity. Examples of non-associative viscosity enhancers include the natural thickeners such as hydroxy ethyl cellulose (HEC), starch, the alkali swellable (or soluble) emulsions (ASE).

The associative viscosity enhancers are usually the hydrophobically modified enhancers. Hydrophobic groups in an aqueous environment results in an inherently unstable, high free energy system. Association of the hydrophobic groups with “other” hydrophobic species in the formulation creates hydrophobic “domain”, ultimately providing a reduction in overall free energy of the system and a more structured compound. Examples of such systems include the hydrophobically modified hydroxy ethyl cellulose, such as Nitrosol PLUS 330 and Nitrosol 430, the hydrophobically modified ethoxylated urethanes (HEUR), such as Drewthix 864, 4020 and 2115 from Ashland Specialty Chemicals.

The associative viscosity enhancers are not usually suitable for the compositions of this invention. The hydrophobic “domains” formed by the associative viscosity enhancers are locked in place during the fast drying induced by the high volatility alcohol of this invention. This locked-in-structure imparts non-uniformity to the dried coating, resulting in a rough and opaque film.

The non-ionic, non-associative viscosity enhancers are preferred for the practice of this invention. In particular hydroxy ethyl cellulose in its various molecular weights, starch and xanthan gum. The alkali swellable (or soluble) emulsions can provide the surface smoothing layers of this invention; however their ionic nature is problematic for environmental stability. If the counter ion is properly picked, it can be released during the curing cycles, for example, triethyl amine or ammonia can be forced out of the coatings at temperature above 125° C.

Some suitable viscosity enhancers are hydroxy ethyl cellulose of various molecular weights and PAC-GEL, pre-gelatinized rice flour specially processed from milled rice. PAC-GEL is sold by PPG International, a division of ACH Food Companies, Inc. of Woodland, Calif.

The hydrophobically modified hydroxy ethyl cellulose, such as the Nitrosol PA 330 and Nitrosol PA 430 from Hercules, are not suitable for the practice of this invention. Even though they provide very high viscosity, the resulting coatings are highly non-uniform and opaque. Possibly, because of incompatibility with the other components of the coating dispersion.

Desirably, the concentration of the viscosity enhancer in the solid coating is from about 0.5 to about 5 wt. % and preferably from about 1 to about 2.5 wt. %.

A last component is a highly volatile water miscible solvent. Such solvents include low molecular weight alkyl alcohols, such as methanol, ethanol, and propanol. Methanol is the preferred alcohol.

These materials are added at a concentration from about 35 to about 60 wt. % of the water in the composition.

By proper adjustment of these materials within the ranges discussed above, the coating composition is readily produced having a viscosity sufficient to produce the desired coating thickness and uniformity upon dip coating or the like. As indicated, spray coating or other types of coating may be used as well, provided that the viscosity is suitably adjusted so that sagging and the like does not occur during or prior to drying of the coated composition on the member.

Desirably, the metal oxides are present in a nanoparticle range (i.e., less than one micron). Desirably, the size of the metal particles is from about 10 to about 100 nanometers.

References to the particle size refer to the largest dimension of the particles.

Coatings are readily applied by the method of the present invention by a method for coating an exterior surface of a cylindrical electrophotographic member such as a roller or the like. These photographic members are typically cylindrical in shape and may be hollow. Desirably the outside surface of such members is coated by the coating method discussed. Similarly, photoconductive films may also be coated by the method of the present invention.

According to the method of the present invention, such members are coated by preparing a coating composition comprising; a dispersion of at least one finely-divided particulate metal oxide in water or alcohol, the dispersion containing at least about 15 wt. % metal oxide and being present in an amount sufficient to produce a metal oxide content in the coating from about 40 to about 80 wt. %; a latex polymer composition in an amount to produce a latex polymer content from about 15 to about 59.5 wt. % in the coating; a water soluble viscosity enhancer in an amount less than about 10 wt. % of the coating; and a water miscible, volatile solvent in an amount equal to from about 35 to about 60 wt. % of the water in the composition.

These members may be drums such as image cylinders and the like. A primary application is the coating of the image cylinders. Similar coatings are used on photoconductive belts comprising a seamless plastic open-ended belt and the like that are used to form images which are thereafter coated with toner and transferred to a substrate. The composition of the present application can be used for all such applications by proper adjustment of the composition to a desired viscosity. Similarly the method for treating the materials is also useful with all such systems.

The coatings applied by the method of the present invention using the composition above comprise from about 40 to about 80 wt. % of the metal oxide, from about 15 to about 59.5 wt. % of the latex polymer and from about 0.5 to about 5 wt. % of the viscosity enhancer.

In instances where the composition is applied by dip coating, the member is desirably withdrawn from the dip coating area at a controlled rate so that the composition is applied uniformly and promptly passed to drying where the composition is dried at a temperature from about 100 to about 150° C. for a time from about 30 minutes to about two hours. Desirably the temperature is from about 120 to about 140° C. for a time from about 45 minutes to about one hour. Desirably the dried coating has a thickness from about 1 to about 15 microns, preferably from about 1 to about 10 microns and more preferably from about 2 to about 10 microns. Further it is desirable that the thickness of the coating vary by less than about +/−0.5 to about 2 microns over the surface of the coated member.

The latex polymer and viscosity enhancer are as discussed above. Desirably the viscosity of the coating solution is from about 5 to about 100 centapoises (cps) at 25° C. Desirably results have been achieved when a viscosity of about 12.7 cps at 25° C. was used. The viscosity can be varied as desired to achieve the desired thickness without running or distortion of the composition on the member prior to drying. Such variations are clearly within the skill of those in the art.

Having discussed the invention by reference to its preferred embodiments, the invention will be further illustrated by the following examples.

### EXAMPLE 1

### Self-cross Linked Polyurethane Tin Oxide Composition

Twenty-one grams of hydroxy ethyl cellulose (molecular weight of 90,000) obtained from Aldrich Chemicals were dissolved in 200 grams of water. To that solution 158.4 grams of a Witcobond W-240 anionic polyurethane water dispersion obtained from Crompton Company of New Jersey, 1161 grams of a 30 wt. % premixed water dispersion of tin oxide SN-100D obtained from Isahara company of Japan, and 1408 grams of methanol were added (44.1 wt. % methanol). The formulation total solids was calculated at 17.5 wt. %. The ratio of methanol to water was 44.1/55.9. The total solids composition (coating) was calculated at 73.5 wt. % tin oxide, 23.5 wt. % W240 PUD, and 3 wt. % hydroxy ethyl cellulose. The viscosity of the mixture was measured at 12.7 cps at 25° C. using a Brookfield viscometer.

The coating mixture was dip coated at 0.05 inch per second on a 5-mil (0.005 inch) nickel sleeve and dried at 130° C. for 1 hour 30 minutes. The coated layer was uniform and transparent. A sample coated on a polyethylene terephthalate (PET) substrate using the same conditions, was evaluated for thickness by cross-section microscopy at about four microns. The coated sample was not attacked by methanol, dichloromethane, 1,1,2 trichloroethane, or combinations thereof.

### COMPARATIVE EXAMPLE 1

### 100% Water

The same procedure as Example 1 was used to prepare another coating mixture, except that no volatile methanol was used. The dip coated sample was axially non-uniform, with many visible ripples. The coated layer was hazy and non transparent.

Effect of Methanol Concentration

Using the same procedure as Example 1, four coating mixtures were prepared at methanol contents respectively of 28.4 wt. %, 31.9 wt. %, 35.2 wt. % and 40 wt. %. Each coating mixture was coated at 2.6 mm/s. and dried at 130° C. for 1 hour 45 minutes. The coated samples were evaluated for axial uniformity, transparency, and surface smoothness; the results are summarized in Table 1 below:

TABLE 1

| | | Coating |
|---|---|---|
| | Wt % Methanol | QUALITY |
| Comparative Example 2 | 28.4 | Non transparent |
| Comparative Example 3 | 31.9 | Non transparent |
| Example 2 | 35.5 | Transparent |
| Example 3 | 40% | Transparent |

Effect Of Tin Oxide Concentration

A series of coating formulations were made using the procedure of Example 1. The composition of the coating mixture was varied according to Table 2 below to result in the appropriate tin oxide (SnO) contents shown. The coating mixtures were dip coated on nickel sleeves at conditions similar to Example 1. The samples were evaluated for surface smoothness by microscopy and profilametry, conductivity, and electrophotographic sensitivity.

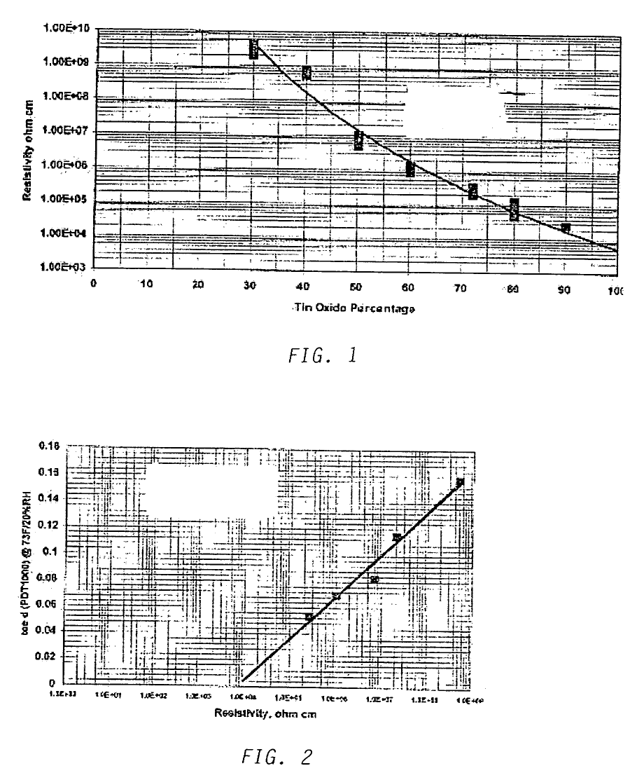

Electrical resistivity (conductivity) is reported on FIG. 1. FIG. 2 shows the effect of conductivity on electrophotographic discharged voltage (V-Toe) for elements using the SnO layers. The higher 90 wt. % loading shows evidence of stress cracking. These cracks are present before heat curing of the coating.

TABLE 2

| Example | W240* | SN100D** | % SnO |
|---|---|---|---|
| 5 | 1554 | 696 | 30 |
| 6 | 1322 | 928 | 40 |
| 7 | 1090 | 1160 | 50 |
| 8 | 1164 | 1962 | 61.7 |
| 9 | 582 | 1658 | 73.5 |
| 10 | 380 | 1800 | 80 |
| Comparative ex. 4 | 158.6 | 2060 | 90 |

*Witcobond W240 @ 27.2% Solid
**SN100D Tin Oxide Water Dispersion @ 30% solid

Titanium Dioxide Composition

Using the procedure of Example 1 the following coating mixtures were made form Titanium dioxide nanoparticle Altium NiNano40 VHPS grade, obtained from Altair Technologies.

TABLE 3

| Example | W240 | Titano40*** | % SnO |
|---|---|---|---|
| 11 | 291 | 500 | 73.6 |
| 12 | 450 | 400 | 60 |
| 13 | 636 | 150 | 45 |

***Titano40 is titanium dioxide Nanoparticle water dispersion @ 38% solid

Titanium dioxide is non-injecting and does not require the use of an injection barrier layer.

### COMPARATIVE EXAMPLE 5

A coating composition was prepared like that of Example 1, except that the viscosity enhancer polymer used was hydrophobically modified hydroxy ethyl cellulose Nitrosol 330)A from Hercules.

The coating mixture was dip coated at 0.05 inches per second on a 5-mil (0.005 inch) nickel sleeve and dried at 130° C. for 1 hour 30 minutes. The coated layer was non-uniform and opaque. A sample coated on a polyethylene terephthalate (PET) substrate using the same conditions was evaluated for thickness by cross-section microscopy at about 12 microns. However, the photomicrography of the coating indicated a very non-uniform coating, unsuitable for the practice of this invention.

### COMPARATIVE EXAMPLE 6

A 180 millimeter (mm) nickel sleeve was dip coated into a solution made of Amilan CM 8000 polyamide from Toray Industries, Japan (24 cps) dissolved in a 90:10 mixture of 1,1,2-trichloroethane: methanol at a withdrawal speed of 3.8 mm/s to yield a coverage of about 0.5 micron. After drying at 100° C., the sleeve was over coated with a charge generation dispersion (3.4% solid) in 100% 1,1,2-trichlorethane at a withdrawal speed of 3 mm/s, followed by drying at 110° C. for 30 minutes. Finally the sleeve was dipped in a charge transport layer solution (300 cps) in dichloromethane at a withdrawal speed of 1.8 mm/s; followed by drying at 100° C. for 30 minutes.

The coated sleeve was mounted on a NexPress 2100 single module testing apparatus for regeneration testing. The testing consisted of charging, exposing, contact with a bias roller, a pre-clean negative charging, and an erase exposure. That sequence, denoted “the cycle”, was repeated 10,000 times. The Vzero and the Vexp voltage (Vtoe) were measured at each cycle. The summary at 500, 1000, 5,000 and 10,000 is shown in Table 4.

### EXAMPLE 14

Another 180 mm nickel sleeve was coated in the same condition as comparable Example 5, except that the sleeve was first coated with a 73.5 wt. % tin oxide undercoat of this invention to yield a tin oxide layer of about 3.5 microns, before the charge transport layer coating. The finished sleeve element of this example was tested for regeneration in the same conditions as comparative Example 5. The results are compared in Table 4. It can be clearly seen that Example 14 provides lower V-toe voltages than the comparative example.

TABLE 4

| | | |
|---|---|---|
| # Of Cycles | Vzero | Vtoe |

Example 14

| | | |
|---|---|---|
| 500 | 493 | 79 |
| 1000 | 493 | 87 |
| 5000 | 491 | 101 |
| 10000 | 491 | 112 |

Comparative Example 5

| | | |
|---|---|---|
| 500 | 497 | 99 |
| 1000 | 499 | 152 |
| 5000 | 471 | 152 |
| 10000 | 448 | 150 |

Upon a review of the foregoing examples, it is clear that desirable uniform coatings are applied using the composition and method of the present invention. These coatings are desirable in composition and in their physical properties as positioned on the electrostatic process members. These coatings are also suitable for use as a substrate for subsequently applied coatings as commonly used in the art.

By the process of the present invention, the use of highly undesirable halogenated solvents, which are considered to constitute an environmental hazard, has been eliminated and a desired coating composition, which provides wide flexibility in the coating composition viscosity and other properties, has been provided.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A composition for dip coating an article, with a coating comprising at least one metal oxide, the composition comprising:
a) a dispersion of at least one finely-divided particulate metal oxide in water or alcohol, the dispersion containing at least about 15 weight percent metal oxide and being present in the composition in an amount sufficient to produce a metal oxide content in the coating from about 40 to about 80 weight percent;
b) a latex polymer composition in an amount to produce a latex polymer content from about 15 to about 59.5 weight percent in the coating;
c) a water soluble viscosity enhancer in an amount less than about 10 weight percent of the coating; and
d) a water miscible, volatile solvent in an amount equal to from about 35 to about 60 weight percent of the water in the composition.

2. The composition of claim 1, wherein the metal oxide is selected from the group consisting of titanium, zirconium, induim, antimony, tin, aluminum and mixtures thereof.

3. The composition of claim 1, wherein the metal oxide is tin oxide or titanium oxide.

4. The composition of claim 1, wherein the finely divided particulate metal oxide comprises particles less than one micron in size.

5. The composition of claim 4, wherein the particles are from about 10 to about 100 nanometers in size.

6. The composition of claim 1, wherein the composition contains from about 15 to about 60 weight percent of the metal oxide aqueous dispersion.

7. The composition of claim 6, wherein the composition contains from about 15 to about 59.5 weight percent of the latex polymer composition.

8. The composition of claim 7, wherein the composition contains from about 0.5 to about 5 weight percent of the aqueous soluble viscosity enhancer.

9. The composition of claim 1, wherein the latex polymer is dispersible in water, water and alcohol mixture and alcohol.

10. The composition of claim 9, wherein the alcohols are selected from methanol, ethanol and propanol.

11. The composition of claim 1, wherein the latex polymer is selected from the group consisting of polyurethane dispersions, polyester polyol dispersions and poly vinyl polyol aqueous dispersions.

12. The composition of claim 1, wherein the viscosity enhancer is exponentially effective as the water concentration decreases.

13. The composition of claim 1, wherein the latex polymer is anionic.

14. The composition of claim 1, wherein the latex polymer contains ammonium carboxylate dispersing groups.

15. The composition of claim 12, wherein the viscosity enhancer is hydroxy ethyl cellulose with a molecular weight, Mw below 500,000.

16. The composition of claim 12, wherein the viscosity enhancer is hydroxy ethyl cellulose with a molecular weight, Mw of 90,000.

17. The composition of claim 12, wherein the viscosity enhancer is at least one of hydroxy ethyl cellulose, starch and xanthan gum.

18. The composition of claim 12, wherein the viscosity enhancer is a non-associative viscosity enhancer.

19. The composition of claim 1, wherein the composition has a viscosity from about 5 to about 100 centipoises at 25 ° C.

20. A method for coating a cylindrical outside surface of a cylindrical electrophotographic member, the method comprising:
a) preparing a coating composition comprising;
1) a dispersion of at least one finely-divided particulate metal oxide in water or alcohol, the dispersion containing at least about 15 weight percent metal oxide and being present in an amount sufficient to produce a metal oxide content in the coating from about 30 to about 80 weight percent;
2) a latex polymer composition in an amount to produce a latex polymer content from about 15 to about 59.5 weight percent in the coating;
3) a water soluble viscosity enhancer in an amount less than about 10 weight percent of the coating; and
4) a water miscible, volatile solvent in an amount equal to from about 35 to about 60 weight percent of the water in the composition.

21. The method of claim 20, wherein the coating comprises from about 40 to about 80 weight percent of the metal oxide, from about 15 to about 59.5 weight percent of the latex polymer and from about 0.5 to about 5 weight percent of the viscosity enhancer.

22. The method of claim 20, wherein the electrophotographic member comprises a drum.

23. The method of claim 20, wherein the electrophotographic member comprises a metal sleeve.

24. The method of claim 20, wherein the electrophotographic member comprises a nickel sleeve.

25. The method of claim 20, wherein the electrophotographic member comprises a seamless plastic open-ended belt.

26. The method of claim 22, wherein the composition on the drum is applied by dip coating.

27. The method of claim 23, wherein the dried coating has a thickness from about 1 to about 10 to about microns.

28. The method of claim 24, wherein the thickness of the coating varies by about +/−0.5 to about 2 microns.

29. A coating composition for an electrophotographic member comprising:
a) from about 40 to about 80 weight percent of at least one metal oxide;
b) from about 15 to about 59.5 weight percent of a latex polymer; and,
c) from about 0.5 to about 5 weight percent of an aqueous soluble viscosity enhancer.

30. The coating of claim 27, wherein the metal oxide is selected from the group consisting of oxides of titanium, zirconium, induim, antimony, tin, aluminum and mixtures thereof.

31. The composition of claim 27, wherein the latex polymer is selected from the group consisting of polyurethane dispersions, polyester polyol dispersions and poly vinyl polyol dispersions.

32. The composition of claim 27, wherein the viscosity enhancer is selected from the group consisting of hydroxy ethyl cellulose of various molecular weights and PAC-GEL, pre-gelatinized rice flour specially processed from milled rice.
